(19) United States
(12) Patent Application Publication
(10) Pub. No.: US 2012/0290615 A1
(43) Pub. Date: Nov. 15, 2012

(54) SWITCHING ALGORITHMS DURING A RUN TIME COMPUTATION

(76) Inventors: Andrew Allinson LAMB, Boston, MA (US); Charles Edward Bear, Hudson, MA (US)

(21) Appl. No.: 13/470,762

(22) Filed: May 14, 2012

Related U.S. Application Data
(60) Provisional application No. 61/485,811, filed on May 13, 2011.

(51) Int. Cl. G06F 17/30; G06F 15/16

(52) U.S. Cl. 707/770; 709/201

(57) ABSTRACT

A system and method for switching algorithms during a run time computation, the method including configuring hardware of a networked cluster of processing elements, each processing element with a memory hierarchy, to perform a first-tier algorithm on input data, the input data having cardinality and stored on one or a plurality of nodes in the networked cluster. Performing at least a portion of a second-tier algorithm and determining whether to complete the second-tier algorithm and perform a third or subsequent tier algorithm, the determination dependent on cardinality. Automatically passing data to an output if the cardinality of the second-tier algorithm is greater than a threshold cardinality, and passing the data back to the second-tier algorithm or to one or a plurality of subsequent algorithms, in response to the cardinality being less than the threshold, and automatically passing the data to an output at the completion of the data processing.

### CROSS REFERENCE TO RELATED APPLICATIONS

This application claims the benefit under 35 U.S.C. §119(e) of U.S. Provisional Application No. 61/485,811, filed on May 13, 2011, the entirety of which is herein incorporated by reference.

### BACKGROUND

Many datasets contain billions or trillions of entries. Databases often serve to organize these datasets and to facilitate queries. Databases may be distributed over many nodes within a network with the underlying data further distributed into numerous files. In some instances, parallel computing over a distributed dataset may provide for powerful searches involving substantial amounts of data.

Finding distinct values in a data set and aggregating similar rows are common calculations. In some instances, data may be distinguished by just one attribute; in other cases the data may be distinguished by multiple attributes. For example, the database may have to compute the total number of distinct users who visited a web site in a given date range. Or, it may have to compute the total number of visits per user per day over the date range; in this case finding and aggregating data by user and date is required. There are well-known methods for computing such results in parallel over very large data sets that do not fit into random-access memory. As an example, the query may be used to find all distinct users who visited a popular website within a certain time period and that have certain demographic traits. The data to be analyzed may be stored such that any particular value may be on many processing elements that must cooperate to reach a solution. While there are several currently known methods for performing these computations, selection of the most efficient one requires prior knowledge about the characteristics of the result of the computation, namely the number of distinct groups of related data (the cardinality). In this example, the cardinality would be the total number of combinations of users and days, for which each user visited the website.

### BRIEF DESCRIPTION OF THE DRAWINGS

Examples are described in the following detailed description and illustrated in the accompanying drawings in which:

FIG. 1 is a flow diagram showing an automatic algorithm selection for high cardinality distinct queries according to an example; and,

FIG. 2 is a schematic illustration of a method of implementing the algorithm according to an example

### DETAILED DESCRIPTION

In the following detailed description, numerous specific details are set forth in order to provide a thorough understanding of the methods and apparatus. However, it will be understood by those skilled in the art that the present methods and apparatus may be practiced without these specific details. In other instances, well-known methods, procedures, and components have not been described in detail so as not to obscure the present methods and apparatus.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

Examples may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of examples as described herein. Examples may include an article such as a non-transitory computer- or processor-readable storage medium, such as for example, a memory, a disk drive, or a USB flash memory encoding, including or storing instructions, e.g., computer-executable instructions, which when executed by a processor or controller, cause the processor or controller to carry out methods disclosed herein.

Different examples are disclosed herein. Features of certain examples may be combined with features of other examples; thus, certain examples may be combinations of features of multiple examples. The foregoing description of the examples has been presented for the purposes of illustration and description. It is not intended to be exhaustive or to limit It should be appreciated by persons skilled in the art that modifications, variations, substitutions, changes, and equivalents are possible in light of the above teaching. It is, therefore, to be understood that the appended claims are intended to cover all such modifications and changes.

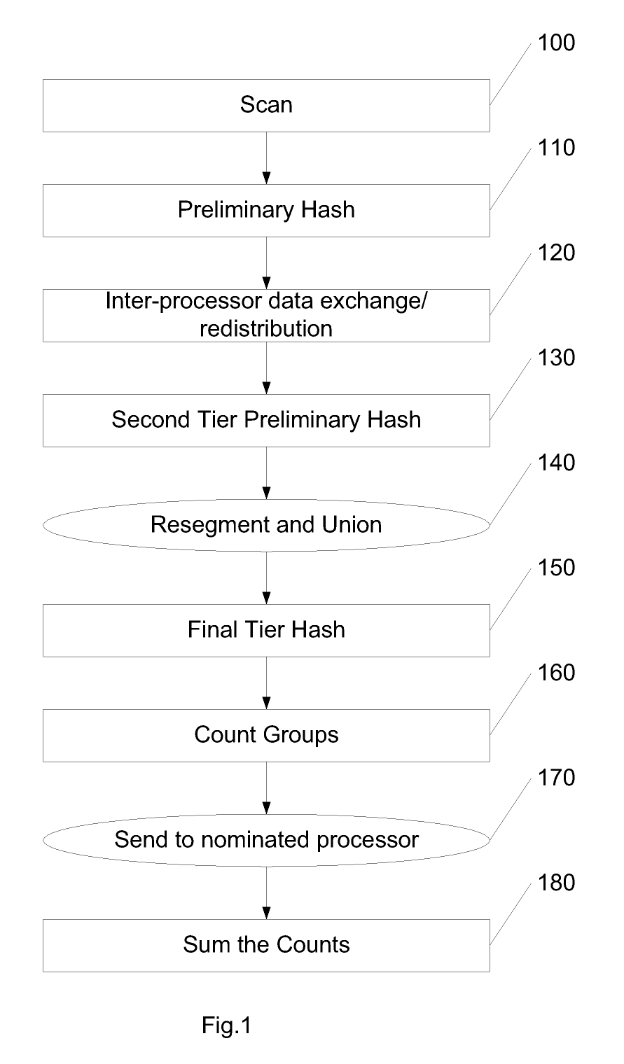

FIG. 1 is a schematic illustration of the algorithm for a COUNT DISTINCT algorithm, according to an example In some examples, other algorithms similar to the count distinct algorithm and with the same design but with different operations returning different results may be employed.

Algorithms may be run on large data sets wherein a user may want to minimize the runtime of the algorithm, e.g., the time it takes the algorithm to process the data in response to a query and provide a result in response to the query. In some examples, the user may want to minimize the computational cost of running an algorithm, independent of the runtime. Most algorithms transform input objects into output objects. The running time of an algorithm may grow with the input size, with an average runtime nevertheless difficult to determine a priori. The running time of an algorithm may also depend on the network structure and architecture, the processor quality and type, the computer quality and type, the input types and amount of input, and the design of the algorithm running the query.

An algorithm for returning a result based on a large dataset within a database may be run on a networked cluster of processors, the processors may, in some instances, have their own memory hierarchies. This memory related to each of the processors may be configured to distinguish each level in the hierarchy by response time. Response time, and in some examples, complexity, and capacity of the memories may be related. In some examples, the hierarchical levels may also be distinguished by the controlling technology.

In some cases, there may be three, four or more major storage levels in the memory hierarchy. These levels include internal memory which may include the processor's registers and cache. These levels may also include a main level of storage that may include system RAM and controller cards. In some examples, a tertiary level in the hierarchy includes on-line mass storage, which may be configured as a secondary memory to the main memory, and off-line bulk storage. Other hierarchical memory structures and levels may also be used, including in some examples a paging algorithm, where the paging algorithm may be considered as a level for virtual memory when designing computer or network architecture.

In some examples, other hierarchical structures of memory may be available and distinguishable from other levels within the hierarchical structure based on size and access time to access the memory. For example, the hierarchical memory structure may include a Level 1 (L1) cache, the L1, in some instances, accessed in just a few cycles, usually tens of kilobytes. A Level 2 (L2) cache, the L2 cache may have a higher latency than L1 by 2× to 10×, usually has 512 KB or more. A Level 3 (L3) cache. The L3 cache may, under some circumstances, be configured to have a higher latency than L2, usually has 2048 KB or more. A main memory section of the memory may in some examples take hundreds of cycles, but can be multiple gigabytes or more in size. General disk storage may also be included in the hierarchical division of the processors' or computers' or networks' associated memory. This level in the hierarchical structure may have millions of cycles of latency if not cached, but may be multiple terabytes in size. And, in some examples the hierarchical storage structure may include tertiary storage; this memory level may have several seconds of latency, but may have a very large disk size.

In some examples, an automatic algorithm selection is used to enhance the efficiency of query operations for computing in parallel the distinct values in a column or columns of a table that covers a large data set distributed over multiple networked processing nodes. Computing in parallel may involve a form of computation in which many calculations are carried out simultaneously, or nearly simultaneously, with large problems divided into smaller ones, or large problems divided into manageable chunks and the smaller problems or manageable chunks of the one problem solved concurrently. In some examples, the parallel computing may be accomplished via a distributed computer, i.e., a scalable distributed memory computer system in which the processing elements are connected, for example, by a network.

A computer cluster may also be employed to conduct the parallel computing. The cluster may be a group of loosely coupled computers that work together closely. In some examples, a computer cluster is composed of multiple standalone machines connected by a network.

In some examples, a massively parallel processor may be employed to conduct the parallel computing. A massively parallel processor (MPP) may include a single computer with many networked processors but sharing other components of the computer. In some examples, the MPP may have specialized interconnected networks.

The data and/or the processing power for the algorithm to answer the query, may in some examples reside on one or more nodes within the system of computers. In some examples, the node is a stand-alone computer, in some examples, the node may be one or a plurality of computer components networked with other computer components.

In some examples, the operation of the query utilizes an algorithm based approach to be run on one or more processors, the processors and their memory as described herein. In some examples, the algorithm is divided into many smaller stand-alone algorithms and/or subroutines including a first, second, third and in some examples, additional distinct algorithms. The number of stand-alone algorithms and/or subroutines may be related to the hierarchical structure of the memory that the algorithm is configured to use.

In some examples, at least one of the algorithms is a grouping algorithm. In some examples, at least one of the algorithms is a grouping and/or hashing algorithm. In responding to a query operation, the algorithm running on the processors associated with the hierarchical memory structure may use a multi-phase hash-based aggregation approach. Other known aggregation approaches are also possible.

A hash or hash operator, in the context of a database refers to algorithms or subroutines that map large data sets of variable length, to smaller data sets, the smaller dataset, in some instances, of a fixed length. In some examples, the multi-phase algorithm includes one or a plurality of phases; the phases may run consecutively to increase efficiency. A hash-based aggregation may, in some examples, increase efficiency in an algorithm by computing all groups concurrently. In some examples, using a multi-phase hash based aggregation approach will provide optimization for the query.

As depicted in box 100, in some examples an initial scan may be performed. In some examples, a scan may include extracting or fetching the data from a source, for example, extracting or fetching the data from a disk within the network, or a disk from outside the network.

In some examples, a scan may be followed with a filter function, wherein some tuples, e.g., rows of data within the dataset, may be filtered out of the analysis. For example, a filter function may filter a data set of individuals who have visited a website by the time of the visit, the date of the visit, the time spent at the visit, the geographical location of the visitor or the type of web browser employed by the visitor during the visit. Other filtering methods and operators are also possible. In some examples, the source may instead be the output of another computation.

As depicted in box 110, a preliminary first tier process, in some examples, an algorithm, for example, a grouping algorithm such as a hashing algorithm, or similar type of algorithm, may be performed. In an example where the algorithm is a hash algorithm, a hash table-based aggregation may be performed in parallel on the data in its highly compressed native form. The a hash table or hash map may be a data structure that uses a hash function to map identifying values, e.g., keys, to their associated values (e.g., a name to the name's telephone number).

The hash table may implement an associative array. The hash function may be used to transform the key into the index (the hash) of an array element where the corresponding value is to be stored. In some examples, the preliminary hashing is for performance optimization. In some examples, the hashing attempts to partially aggregate the data stream before the data is streamed through the rest of a data pipeline for the query.

The hash table may, in some examples, be sized to fit in the L1 and/or L2 cache of the processor to maximize efficiency and/or concurrency. In some examples, the L2 cache may be part of a multi-level storage hierarchy, as described above with reference to the hierarchical memory of the processors, the components of the multi-level storage cache configured to bridge the gap between a fast computer processing unit (CPU) and a slower random access memory (RAM) unit. Typically, the L2 cache is built into the motherboard of a computer. In some examples, the L2 cache may be incorporated into the CPU and may be configured to anticipate data requests from the CPU. The multi-level storage cache, including L2 may be made from static RAM (SRAM) chips, or is placed directly on the CPU die.

As depicted in box 120, an inter-processor data exchange/redistribution may be performed. The exchange/redistribution may, in some instances, occur between processors within the same computer network, or within the same computer. The exchange/redistribution may, exchange data over memory buses; the buses may be a subsystem that transfers data between components, e.g., multiple processors, inside a computer. The memory bus is, may under some conditions, be the bus that connects the CPUs and their caches to the main memory on the motherboard. In some examples, the inter-processor exchange/redistribution occurs between multiple processors on multiple nodes within the network.

The inter-processor data exchange/redistribution may occur when one processor cannot compute the solution on its own and passes some of the data, or exchanges some of the data for data from another processor on another node or another processor within the same computer. In some examples, when SQL is used, an Exchange Operator may be employed. A parallel plan may also be executed by SQL by concurrently running multiple instances of a serial plan, each process on an initial processor.

Each serial plan is a single task, run by a dedicated processor thread inside its own execution context. In some examples, the exchange operator may connect together each of the execution contexts of the parallel plan. More generally, a complex query plan might contain any number of serial or parallel regions, connected by exchange operators.

The exchange operator may be used to move rows between one or more processors, distributing the individual rows among them as the data is inputted and/or initially processed.

In some examples, different logical forms of the operator are used by an SQL Server or other database server that implements the Structured Query Language or similar database languages, interacting with the dataset to introduce a new serial or parallel region, or to redistribute rows at the interface between two parallel regions. In some examples, the exchange operator may split, combine, or redistribute rows among the interconnected processors.

As depicted in box 130, at least a portion, and in some examples, the entirety of a second tier and/or preliminary hash table aggregation on at least a subset of the data may be performed by each node in the cluster. The hash table is, in some examples, sized to fit in the main memory of the node, and in some examples, may be a larger memory cache than the memory cache employed by the first tier algorithm.

A second tier preliminary process, algorithm, grouping algorithm or the like, or a hash table aggregation algorithm, may be employed by the algorithm when the number of distinct values in the data stream fits in the main memory, but not in the L2 cache. The size of the L2 cache, may, in some instances, define the size of the buffer used by the preliminary hash, the preliminary hash described above.

In some examples, a grouping algorithm may include one or many different group by algorithms, for example, as may be used in SQL. One grouping algorithm may include the hash algorithm. A hash algorithm, as described herein may, in some circumstances, aggregate input records in a temporary hash table. Once all input records are processed, the hash-table is returned as result, or an output to a subsequent, for example, third tier, algorithm.

In some examples, a sorting algorithm may be employed in a final algorithm. The sorting algorithm may be used when there are many groups and where the cost of sorting is less than the cost of random accesses based on hashing. The computational cost of sorting may be cheaper than the computational cost of hashing on data sets where the cardinality exceeds the capacity of random access memory.

In some examples, a second tier algorithm may be used in interacting with a database, including via SQL, may be a sort/group algorithm. In this example of a second tier algorithm one or a plurality of processors may be configured to sort the input data by a grouping key first. Thus, making rows, e.g., tuples, of each group follow consecutively so they just need to be aggregated.

In some examples, the properties of the data stream may include cardinality. If the cardinality out of the second tier preliminary hash is 70-90% or greater than the cardinality of the input, the second tier hash may, in some examples, stop aggregating and simply passes its input to the output. Cardinality may refer to the uniqueness of data values contained in a particular column or set of columns of a database table. The lower the cardinality, the more duplicated elements in a column.

In some examples, in a relational database model, tables may be related as any of: many-to-many, many-to-one (or its inverse, one-to-many), or one-to-one. This is said to be the cardinality of a given table in relation to another.

In SQL (Structured Query Language), the term cardinality typically refers to the uniqueness of data values contained in a particular column (attribute) of a database table. The lower the cardinality, the more duplicated elements in a column. Thus, a column with the lowest possible cardinality would have the same value for every row. SQL databases may use cardinality to help determine the optimal query plan for a given query.

In some examples, when dealing with columnar value sets, there are 3 types of cardinality: high-cardinality, normal-cardinality, and low-cardinality.

High-cardinality, may, in some instances refer to columns with values that are very uncommon or unique. High-cardinality column values may include identification numbers, email addresses, or user names When most values held in a column are unique, this column's cardinality type would be referred to as high-cardinality.

Normal-cardinality refers to columns with values that are somewhat uncommon Normal-cardinality column values may include names, street addresses, or vehicle types and others. Since there are a variety of possible values held in this column, some overlapping, its cardinality type would be referred to as normal-cardinality.

Low-cardinality refers to columns with few unique values. Low-cardinality column values are may include among others, status flags, Boolean values, or major classifications such as gender, and other examples. In some examples, e.g., when there are only 2 possible values held in a column, its cardinality type would be referred to as low-cardinality.

A threshold of cardinality may, in some instances, be set to optimize the algorithm described herein. The threshold being relevant to determine whether the algorithm should continue on the current node or be transferred to another node within the clustered network, as described herein. In some examples, the threshold cardinality may be a high percentage, for example between 70 and 100%, e.g., 90%. A column with the lowest possible cardinality would have the same value for every row. High-cardinality may, in some examples, refer to columns with values that are very uncommon or unique.

Automatic selection at query execution time provides flexibility in the process execution and makes the query performance less susceptible to plan choices. The query optimizer can by default create a plan that includes a second-tier preliminary hash, and does not have to distinguish between the cases where the secondary increases efficiency and the cases where it does not. The runtime system can adjust the process to include the secondary hash or not, based on the actual data that is seen.

In some examples, the second tier preliminary hash may not enhance the performance when the hashing does not significantly reduce the cardinality due to a large number of distinct values. In that case, performing the second-tier hash may actually degrade the performance by slowing down the execution and becoming relatively computationally expensive relative to the alternatives.

In instances where the algorithm determines that performing the second-tier hash or other second tier algorithms may actually degrade the performance and slow down the execution, the second tier preliminary hash that occurs on individual nodes or on each node in the networked cluster may independently and/or automatically switch algorithms at runtime depending on the properties of the data stream and the hash will not be performed.

In some examples, the algorithm may determine that the computational cost of running the current hash algorithm on the current processor is not justified by the end result and may transfer the running computation to another algorithm on other nodes or processors within the network, this second computation potentially being more capable of performing the component of the query in a less expensive manner relative to the first attempt.

In some examples, the second tier hash is performed, for example, when it is determined that the computational expense of continuing the second-tier hash on the current node is equal or less than the computational cost of shifting the computation to another node within the networked cluster, the computational cost determined, in some examples, with regard to the threshold cardinality.

As depicted in box 140, after the second-tier preliminary hash table aggregation, the data may be redistributed between different processors in the same machine, or for examples, between different processors in different machines, and in some examples, to a computation that the algorithm may consider to be more capable of handling a current task. In some instances, the node may continue processing the next stage of the algorithm in response to the query.

In some examples, the redistribution may be a resegment+union operation around a cluster such that each node in the network—each node as described herein, the node potentially being a processor within the same computer or a separate processor within a separate computer, or similar devices, may have a distinct subset of grouping keys, the distinct subset of keys may, in some circumstances, be assigned to the node at the outset of the running of the algorithm. In some examples, the distribution of data may be set by the results of initial hashing, such that depending on the result the next step in the algorithm may be handled by a particular machine or processor.

In some examples, fail-safes may exist at any point in responding to the query, and there may be, for example redundancies in the processing of the data via the algorithm such that multiple nodes may process similar, identical or overlapping data.

Box 140 may, in some examples, represent a stage where the processors and/or computers in a cluster exchange data over a network. In some examples, the exchange of data over the network includes data swaps such that all machines or processors are running efficiently. The exchange of data may include an exchange of data between peer machines, such that no partner in the exchange is necessarily more capable from a physical computer architecture standpoint to process the data. In some examples, the swapping and/or exchanging of data may be between non peer machines. Similar to the description above with reference to box 120, the algorithm may be configured to introduce preliminary stages; the preliminary stages inserted based on the hardware configuration, to reduce data volume prior to data exchanges, the data exchanges may be costly and time-consuming.

In some examples, when exchanging data, the system may be configured such that all instances of each distinct key value, described herein with relation to cardinality, are sent to a single processor or a single node, and in some examples, mapped using a hash function. In examples, the system may be configured such that all instances of each distinct key value, described herein with relation to cardinality, are sent to a single processor or a single node; the system may be configured to maximize the chances that duplicates can be eliminated in a fixed amount of memory within the system.

As depicted in box 150, a third tier hash-table aggregation may be performed on each node in a cluster. In some examples other forms of algorithms similar or distinct from a hash-table algorithm may be performed instead of the hash table algorithm.

The total number of subroutines, or tiers of algorithms performed by the algorithm, may in some instances be correlated with the number of memory types in the memory hierarchy are to be used by the system running the algorithm. In some examples, when the algorithm is being run on three levels of memory hierarchy within the memory hierarchy of the clustered network or individual computer, the memory hierarchy described herein, then three grouping, sorting and or hashing algorithms may be performed, i.e., the number of algorithms that are run is three.

Other additional algorithms outside of these may also be performed. In some instances, this third tier hash table may spill-over to disk based storage if its allotted memory, e.g., the main memory, is exhausted. When the third tier hash, grouping, sorting or similar algorithm is a final tier hash aggregation step, the final tier may be performed for data correctness: e.g., only one row per group is created.

In some examples, the query may be optimized by adding more nodes in the analysis. In some examples, with n nodes, each node will process 1/n of the rows, and 1/n of the groups. Increasing the nodes may increase the performance, with the possibility of superlinear scaling if the number of groups starts to fit in the main memory. Measures that scale superlinearly may, in some instances, increase consistently at a nonlinear rate greater than one for one.

In some examples, a count group operation is performed in addition to the sorting, grouping, hashing or similar algorithms, as indicated by box 160. Other operations may also be performed on the data, in some examples, SQL operations.

As depicted in box 170, after a count group operation is performed, the data may be sent to an initiator, or, in some examples, to a nominated processor. In some examples, after the count group operation is performed the data may be sent to a component of the algorithm, the component configured to indicate that an operation is no longer parallel, e.g., that the parallel computing portion of the algorithm has completed and the data has been handed off to a single machine to report back the results of the query that initiated the algorithm described herein. some circumstances, the machine that reports the data resulting from the query is also the initiator, e.g., the machine or terminal from where the query initiated and was eventually divided up to be processed within the network.

The counts may be summed, as depicted in box 180 and the data may be presented back, in some instances, as the result of the query. In some examples, further algorithms may be employed to further process the data.

In some examples, the algorithms described above, designed to run on a distributed system with different processors residing on distinct nodes in a network, and in some examples, with data residing on different nodes in the network, may be used in aggregation queries—e.g., to find number of distinct entries in a large data set given a one or a plurality of characteristics. For example, the algorithm may be used to determine all the users on a website, grouped by a characteristic such as date. The above mentioned algorithm provides a method to do this quickly. The algorithm may, in some instances, be configured to run independent of the underlying database structure.

The algorithm may provide two pathways, depending on how many unique values need to be analyzed. The algorithm provides for a choice between two different subsequent algorithms. In some examples, the algorithm may be configured to adapt at run time to determine what subsequent algorithms need to be implemented. This calculation to determine which subsequent algorithm should be implemented, may, in some examples, be calculated in multiple different phases of the query and may provide branch points at other points of the query, in addition to the branch points described above and below.

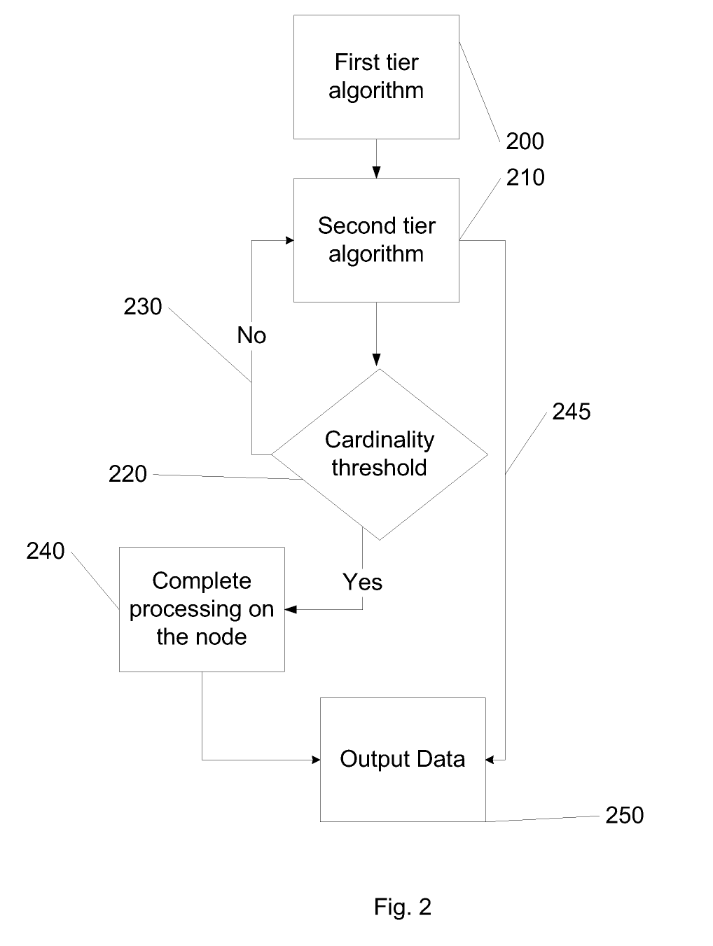

FIG. 2 is a schematic illustration of a method of implementing the algorithm, configured to run a query, according to an example.

The query may, in some instances, be on a large data set, the data set, in some examples, residing in multiple nodes in a distributed database, the database may be set in a clustered network or computers and/or processors.

In some examples, the query may be configured to determine some information regarding the data set. In some examples, the data set may be a large data file relating to third party web browsing. In some examples, the data set may be a large data file relating to consumer data. In some examples, the data file may have a lot of repetitive keys. In some examples, the data file may have a lot of unique keys.

In some examples, computational power for running the algorithm resides on a distributed network, with the computational power divided among multiple nodes in the network.

Box 200 depicts a preliminary hash run by the algorithm in response to a query from a user. The size of a buffer for the preliminary hash within the algorithm may be, in some cases, related to the first tier in the memory hierarchy, e.g., L1 or L2.

In some examples, the size of the buffer reserved for the algorithm may be related to another tier in the memory hierarchy. In some examples, the first component of the algorithm is another subroutine similar to a hash. In some examples the first component of the algorithm may be a sorting or grouping operation or similar operation.

Box 210 depicts a secondary hash run by the algorithm. The secondary hash component of the algorithm may, in some examples, be configured to determine a characteristic of the data and the data processed by the first preliminary hash. In some examples, the buffer for the secondary hash may be related to a second tier in the memory hierarchy. For example, the buffer for the secondary hash may be related to the system's main memory, as described above.

In some examples, the algorithm may run an operation similar to a hash instead of a secondary hash. In some examples, the algorithm may run a sort or grouping operation. In some examples, cardinality of the data may be assessed before or during the running of the secondary hash or similar algorithm, as depicted by decision diamond 220.

At decision diamond 220 a decision may be made as to whether the data streaming into the query may be further reduced sufficiently such that the cost of continuing the secondary hash or other algorithm, described herein, is warranted by the reduction of data volume sent downstream to subsequent components of the algorithm, or that the data cannot be reduced anymore due to the cardinality of the data. In some examples, the threshold for cardinality may be between 50 and 100%, for example, between 70 and 95%, e.g., 90%, as described above.

In some examples, a threshold for the cardinality of the data may be determined based on additional factors. The threshold may represent a relationship between cardinality of the data and the size of the buffer to be used processing the data. In some instances, the threshold is further related to computational cost wherein the threshold for determining whether to continue to process the data at the current node or to send the data to a second node within the system may be related to relationship between the current computational cost of processing the data and the computational cost of sending the data to a different node in the system.

In instances wherein the processor, or individual node within the networked cluster, at decision diamond 220, determines that the data cannot be further processed economically, i.e., the cardinality threshold is reached, then that node may complete processing that data component of the query as depicted in box 240 and the data may be swapped, shunted, or otherwise sent to another node or processor for further processing, as depicted in box 250 where the data is outputted to a node or processor.

In some examples, when the cost of further reducing the data is more expensive computationally than sending the data across the network to a different node, then the algorithm will send the data to a different node. When the cost of further reducing the data is less expensive computationally, for example, when the cardinality threshold is not yet reached, then sending the data to a different node in the network, then the present node will continue running the algorithm, as depicted in loop 230, and may continue to run the second tier hash, looping back to box 210.

In some instances, once the secondary hash has been completed, the algorithm will continue as described above with reference to FIG. 1. The completed results of the secondary hash, as represented by box 210, may then be sent, here depicted as path 245 and outputted as data. The outputted data in some examples passed on to be further operated on by a third or subsequent tier algorithm, in some examples, the outputted data being returned to the uses as the result of the query.

In some examples, when cardinality is determined to be high, i.e., there are not numerous repeat entries in the dataset, then the algorithm maybe configured to disable the secondary hash on the current node, as depicted in box 240 and output the data as depicted in box 250. The outputted data, may, in some circumstances, be shunted or passed to another node within the networked cluster.

In some examples, the outputted data is submitted to a subsequent algorithm within the larger algorithm, in some examples, the subsequent, for example, third tier, algorithm may be processed by the current node. In some examples, another node within the networked cluster may operate on the data in the third tier algorithm.

This algorithm, described above, may be more computationally sophisticated than the first and the second tier algorithms. In some examples, the subsequent algorithms are more computationally correct than the first tier algorithm and the second tier algorithm.

In some examples, more computationally sophisticated, and/or more sophisticated algorithms than the hash, group and/or sort algorithms that may be used in the first tier algorithm and the second tier algorithm may include sorting or radix algorithms.

One or a plurality of algorithms may continue to process the data among multiple nodes and/possessors and an output is eventually provided, as depicted in box 250. The algorithm may, in some instances, be a response to the query posed.

In some examples, the nature of the algorithms and the queries may differ from what has been described herein and above.

In the foregoing description, numerous details are set forth to provide an understanding of the present example. However, it will be understood by those skilled in the art that the present example may be practiced without these details. While the example has been disclosed with respect to a limited number of embodiments, those skilled in the art will appreciate numerous modifications and variations there from. It is intended that the appended claims cover such modifications and variations as fall within the true spirit and scope of the example.

What is claimed is:

1. A method of switching algorithms during a run time computation, the method comprising:
configuring hardware of a networked cluster of processing elements, each processing element coupled to one or a plurality of levels of memory hierarchy, to perform a first tier algorithm on input data, the input data having cardinality and stored on one or a plurality of nodes in the networked cluster;
performing a least a portion of a second tier algorithm;
determining whether to complete the second tier algorithm and perform a third or subsequent tier algorithm, the determination dependent on a threshold of cardinality;
automatically passing data to an output if the cardinality of the second tier algorithm is greater than a threshold cardinality; and,
passing the data back to the second tier algorithm or to one or a plurality of subsequent algorithms, in response to the cardinality being less than the threshold, and automatically passing the data to an output at the completion of processing by the second tier algorithm or to one or a plurality of subsequent algorithms.

2. The method of claim 1, wherein the threshold of cardinality of the second tier algorithm is configured to be equal to or less than a percentage of the cardinality of the input.

3. The method of claim 1, wherein one or a plurality of the algorithms are grouping algorithms.

4. The method of claim 1, wherein one or a plurality of the algorithms are hashing algorithms.

5. The method of claim 1, wherein one or a plurality of subsequent algorithms are more sophisticated than the first and second tier algorithms.

6. The method of claim 1, wherein the number of algorithms is correlated with the levels of memory hierarchy employed by the networked cluster.

7. A non-transitory computer readable medium to execute a query to find distinct values in a table column, comprising instructions, which when executed cause a processor to perform a first tier algorithm on input data, the input data having cardinality and stored on one or a plurality of nodes in a networked cluster, each node coupled to one or a plurality of levels of memory hierarchy; and,
performing a least a portion of a second tier algorithm,
determining whether to complete the second tier algorithm and perform a third or subsequent tier algorithm, the determination dependent on a threshold of cardinality;
automatically passing data to an output if the cardinality of the second tier algorithm is greater than a threshold cardinality; and,
passing the data back to the second tier algorithm or to one or a plurality of subsequent algorithms, in response to the cardinality being less than the threshold, and automatically passing the data to an output at the completion of processing by the second tier algorithm or to one or a plurality of subsequent algorithms.

8. The non-transitory computer readable medium of claim 7, configured to set the threshold of cardinality for the second tier algorithm to be equal to or less than a percentage of the cardinality of the input.

9. The non-transitory computer readable medium of claim 7, wherein one or a plurality of the algorithms are grouping algorithms.

10. The non-transitory computer readable medium of claim 7, wherein one or a plurality of the algorithms are hashing algorithms.

11. The non-transitory computer readable medium of claim 7, wherein one or a plurality of subsequent algorithms are more sophisticated than the first and second tier algorithms.

12. The non-transitory computer readable medium of claim 7, wherein the number of algorithms to be run is correlated with the levels of memory hierarchy employed by the networked cluster.

13. A system for switching algorithms during a run time computation, the system comprising:
hardware within networked cluster of processing elements, each processing element with its own memory hierarchy, to perform a first tier algorithm on input data, the input data having cardinality and stored on one or a plurality of nodes in the networked cluster each node coupled to one or a plurality of levels of memory hierarchy;
one or a plurality of processors performing a least a portion of a second tier algorithm;
one or a plurality of the processors determining whether to complete the second tier algorithm and perform a third or subsequent tier algorithm, the determination dependent on a threshold of cardinality;
one or a plurality of the processors automatically passing data to an output if the cardinality of the second tier algorithm is greater than a threshold cardinality; and,
one or a plurality of the processors passing the data back to the second tier algorithm or to one or a plurality of subsequent algorithms, in response to the cardinality being less than the threshold, and automatically passing the data to an output at the completion of processing by the second tier algorithm or to one or a plurality of subsequent algorithms.

14. The system of claim 13, wherein the threshold of cardinality for the second tier algorithm is configured to be equal to or less than a percentage of the cardinality of the input.

15. The system of claim 13, wherein one or a plurality of the algorithms are grouping algorithms.

16. The system of claim 13, wherein one or a plurality of the algorithms are hashing algorithms.

17. The system of claim 13, wherein one or a plurality of subsequent algorithms are more sophisticated than the first and second tier algorithms.

18. The system of claim 13, wherein the number of algorithms to be run is correlated with the levels of memory hierarchy employed by the networked cluster.
